(19) United States
(12) Patent Application Publication
(10) Pub. No.: US 2005/0061073 A1
(43) Pub. Date: Mar. 24, 2005

(54) Vibratory gyroscope and electronic apparatus

(75) Inventors: Shigeo Kanna, Shimosuwa-machi (JP); Makoto Eguchi, Suwa-shi (JP); Junichiro Shinozaki, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/909,359

(22) Filed: Aug. 3, 2004

(30) Foreign Application Priority Data
Aug. 4, 2003 (JP) 2003-286215
Jun. 22, 2004 (JP) 2004-183655

(51) Int. Cl. G01P 15/08

(52) U.S. Cl. 73/504.04

(57) ABSTRACT

To provide a vibratory gyroscope capable of detecting a change in posture with high accuracy without causing leaking of vibrations of vibrating bars via supporting units, a vibrator includes first to fourth vibrating bars extending parallel to each other substantially in the same plane, a bar-shaped beam extending substantially perpendicular to the four vibrating bars in the same plane and connected to the vibrating bars, bar-shaped supporting units to support the beam, driving units arranged in the third and fourth vibrating bars, and a detecting unit arranged the first vibrating bar.

### BACKGROUND OF THE INVENTION

1. Field of Invention

An exemplary aspect of the present invention relates to a vibratory gyroscope, such as, for example, a vibrating-type gyroscope and an electronic apparatus including the vibrator.

2. Description of Related Art

In a vibratory gyroscope (hereinafter “vibrator”), in order to detect a change in the posture of the vibrator, vibrating bars perform driving vibration. Detecting vibrations is generated by a Coriolis force when the change of posture is generated. In the vibrator, the vibrations generated in the vibrating bars leak to a circuit board on which the vibrator is mounted. This may result in differences between frequencies of the driving vibration and the detecting vibration. Thus, in order to reduce the difference between the frequencies of both vibrations, a vibrator described in U.S. Pat. No. 5,396,144 provided with a suspension system to support the vibrating bars.

### SUMMARY OF THE INVENTION

However, even if the related art vibrator has a suspension system, a problem may occur in that the vibrations of the vibrating bars cannot be sufficiently prevented from leaking to the circuit board that supports the vibrator. In addition to this problem, a change in shape of a beam caused by leakage of both vibrations is incorrectly recognized as a change in shape of the beam caused by a Coriolis force.

An exemplary aspect of the present invention has been made to address the above and/or other problems. An exemplary aspect of the present invention provides a vibratory gyroscope capable of detecting changes in posture of the vibration with high accuracy without causing leaking of vibrations of vibrating bars via supporting units.

A vibrator according to an exemplary aspect of the present invention includes: first, second, third and fourth vibrating bars extending parallel to each other and substantially in the same plane. The first vibrating bar and the second vibrating bar are arranged at an outermost side. The third vibrating bar and the fourth vibrating bar are arranged between the first vibrating bar and the second vibrating bar. The third vibrating bar is arranged at a position near the first vibrating bar. The fourth vibrating bar is arranged at a position near the second vibrating bar. A bar-shaped beam extends substantially perpendicular to the four vibrating bars and in the same plane and is connected to the four vibrating bars. Bar-shaped supporting units are provided to support the beam. Driving units are arranged at at least two of the four vibrating bars. A detecting unit is arranged at at least one of the four vibrating bars. The vibrating bars are driven and vibrated by the driving units. Rotation about an axis of rotation, which is the direction in which the vibrating bars extend, is detected by deformation of the at least one vibrating bar at which the detecting unit is arranged.

According to the vibrator related to an exemplary aspect of the present invention, at least two vibrating bars perform driving vibration, and when the rotation is generated, performs detecting vibration generated in the first, second, third and fourth vibrating bars by a Coriolis force. As a result, the shape of the vibrating bars changes. Accordingly, the detecting unit provided in at least one vibrating bar can detect a change in shape of the vibrating bars and detect the rotation.

Further, in the vibrator according to an exemplary aspect of the present invention, the supporting units may be formed to extend in a direction in which the beam and the vibrating bars extend, and to intersect the beam.

Further, in the vibrator according to an exemplary aspect of the present invention, the supporting units may be formed to intersect at substantially the center of the length of the beam.

Further, in the vibrator according to an exemplary aspect of the present invention, the supporting units may be formed at ends of the beam which extend outward from the first vibrating bar and the second vibrating bar.

Further, in the vibrator according to an exemplary aspect of the present invention, the supporting units may include a frame member surrounding the first to fourth vibrating bars from the outside.

According to the vibrators of the above constructions, wiring from the detecting unit and driving units can be arranged in the supporting units, and the degree of freedom in design can be increased. If the supporting units are bonded to and held in a vibrator container, a sufficient adhesion area can be obtained and the vibrator can be firmly held in the container.

In the vibrator according to an exemplary aspect of the present invention, the beam may be connected to the vibrating bars at substantially the center of the lengths which the first to fourth vibrating bars extend.

In the vibrator according to an exemplary aspect of the present invention, the first and third vibrating bars and the second and fourth vibrating bars may be provided at positions which are symmetrical with respect to a straight line passing through the center of the beam and parallel to the vibrating bars.

According to the vibrators of the above constructions, since the vibrating bars become symmetrical with respect to a straight line passing through the center of the beam and extending parallel to the vibrating bars, the respective vibrating bars vibrate in a well-balanced state without leaking of the vibration of the vibrating bars to the beam, thereby providing a vibrator having excellent characteristics.

In the vibrator according to an exemplary aspect of the present invention, the driving units may be included in the first vibrating bar and the second vibrating bar, or the driving units may be included in the third vibrating bar and the fourth vibrating bar.

In the vibrator according to an exemplary aspect of the present invention, when the driving units are provided in the first vibrating bar and the second vibrating bar, the driving units drive the first vibrating bar and the second vibrating bar so that the vibrations of the first and second vibrating bars are in anti-phase to each other. When the driving units are provided in the third vibrating bar and the fourth vibrating bar, the driving units drive the third vibrating bar and the fourth vibrating bar so that the vibrations of the third and fourth vibrating bars are in anti-phase to each other.

In the vibrator according to an exemplary aspect of the present invention, the detecting unit is included in at least the first vibrating bar and the second vibrating bar, at least the third vibrating bar and the fourth vibrating bar, at least the first vibrating bar and the third vibrating bar, or at least the second vibrating bar and the fourth vibrating bar.

According to the vibrator related to an exemplary aspect of the present invention, two vibrating bars perform driving vibration, and when the rotation is generated, perform detecting vibration generated in the first, second, third and fourth vibrating bars by a Coriolis force. As a result, the shape of the vibrating bars is changed. Accordingly, the detecting unit provided in at least two vibrating bars can detect a change in shape of the vibrating bars and detect the rotation. Further, the acceleration that is a disturbance for the rotation can be detected by at least two detecting units. The acceleration can be distinguished from the rotation, such that it is possible to obtain a vibrator capable of detecting a change in posture with high accuracy.

In the vibrator according to an exemplary aspect of the present invention, the driving units may be included in the first, second, third and fourth vibrating bars.

In the vibrator according to an exemplary aspect of the present invention, the driving units drive the vibration of the first, second, third and fourth vibrating bars such that the vibration of the first vibrating bar and the vibration of the second vibrating bar are in phase to each other, the vibration of the third vibrating bar and the vibration of the fourth vibrating bar are in phase to each other, and the vibration of the first vibrating bar and the vibration of the third vibrating bar are in anti-phase to each other.

In the vibrator according to an exemplary aspect of the present invention, the detecting unit is included in at least the first vibrating bar and the fourth vibrating bar, at least the second vibrating bar and the third vibrating bar, at least the first vibrating bar and the third vibrating bar, or at least the second vibrating bar and the fourth vibrating bar.

In the vibrator according to an exemplary aspect of the present invention, the driving units drives the vibration of the first, second, third and fourth vibrating bars such that the vibration of the first vibrating bar and the vibration of second vibrating bar are in anti-phase to each other, the vibration of the third vibrating bar and the vibration of the fourth vibrating bar are in anti-phase to each other, and the vibration of the first vibrating bar and the vibration of the third vibrating bar are in anti-phase to each other.

In the vibrator according to an exemplary aspect of the present invention, the detecting unit is included in at least the first vibrating bar and second vibrating bar, at least the first vibrating bar and the third vibrating bar, at least the second vibrating bar and the fourth vibrating bar, or at least the third vibrating bar and the fourth vibrating bar.

According to the vibrator of an exemplary aspect of the present invention, four vibrating bars perform driving vibration, and when the rotation is generated, perform detecting vibration generated in the first, second, third and fourth vibrating bars by a Coriolis force. As a result, the shape of the vibrating bars is changed. Accordingly, the detecting unit provided in at least two vibrating bars can detect a change in shape of the vibrating bars and detect the rotation. Further, the acceleration that is a disturbance for the rotation can be detected by at least two detecting units, and the acceleration can be distinguished from the rotation, such that it is possible to obtain a vibrator capable of detecting a change in posture with high accuracy.

An electronic apparatus according to an exemplary aspect of the present invention includes the vibrator of an exemplary aspect of present.

According to an electronic apparatus of an exemplary aspect of the present invention, a vibrator capable of detecting a change in posture with high accuracy is provided, such that it is possible to provide an electronic apparatus exhibiting a good performance.

### BRIEF DESCRIPTION OF THE DRAWINGS

FIG. 1 is a schematic of the construction of a vibrator of exemplary Embodiment 1;

FIGS. 2A and 2B are schematics of the drive mode of the vibrator of exemplary Embodiment 1;

FIGS. 3A-3C are schematics of the detecting mode of the vibrator of exemplary Embodiment 1;

FIGS. 4A and 4B are schematics of the drive mode of a vibrator of a modification of exemplary Embodiment 1;

FIGS. 5A and 5B are schematics of the drive mode of a vibrator of exemplary Embodiment 2;

FIGS. 6A and 6B are schematics of the detecting mode of the vibrator of exemplary Embodiment 2;

FIG. 7 is a schematic of a state in which the vibrator of exemplary Embodiment 1 is mounted in a vibrator container;

FIGS. 8A and 8B are schematics of modifications in the arrangement of supporting units of exemplary Embodiment 1;

FIGS. 9A and 9B are schematics of modifications in the arrangement of supporting units of exemplary Embodiment 1;

FIGS. 10A and 10B are schematics of a modification when a plurality of detecting units in exemplary Embodiment 1 are provided;

FIG. 11 is a schematic of the construction of a vibrator of exemplary Embodiment 3;

FIGS. 12A and 12B are schematics of the drive mode of the vibrator of exemplary Embodiment 3;

FIGS. 13A-13C are schematics of the detecting mode of the vibrator of exemplary Embodiment 3;

FIGS. 14A and 14B are schematics of a state in which the vibrator of exemplary Embodiment 3 is mounted in a vibrator container;

FIGS. 15A and 15B are schematics of modifications in the arrangement of supporting units of exemplary Embodiment 3;

FIG. 16 is a schematic of a modification in the arrangement of supporting units of exemplary Embodiment 3;

FIGS. 17A and 17B are schematics of a modification when a plurality of detecting units in exemplary Embodiment 3;

FIG. 18 is a schematic in which the vibrators of the present exemplary embodiments are built in an applied apparatus;

FIGS. 19A and 19B are schematics of another drive mode of the vibrator of exemplary Embodiment 2;

FIGS. 20A and 20B are schematics of another detecting mode of the vibrator of exemplary Embodiment 2; and

FIGS. 21A and 21B are schematics of a modification when a plurality of detecting units in exemplary Embodiment 2 is provided.

### DETAILED DESCRIPTION OF EXEMPLARY EMBODIMENTS

Exemplary embodiments of a vibrator according to an exemplary aspect of the present invention will be described with reference to the drawings.

Exemplary Embodiment 1

A vibrator of exemplary Embodiment 1 has a drive mode that performs driving vibration to excite a Coriolis force and a detecting mode that performs detecting vibration generated by the Coriolis force. Hereinafter, after the construction and the drive mode of the vibrator of exemplary Embodiment 1 have been described together, the detecting mode will be described.

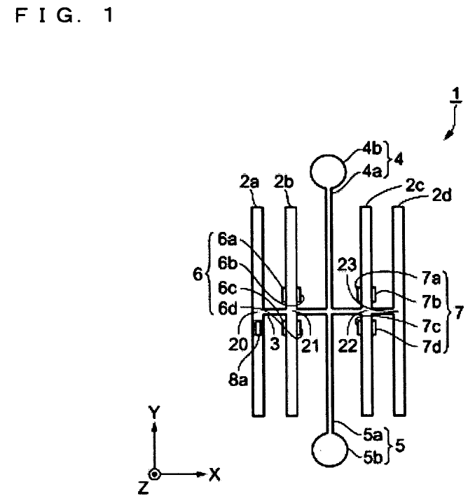

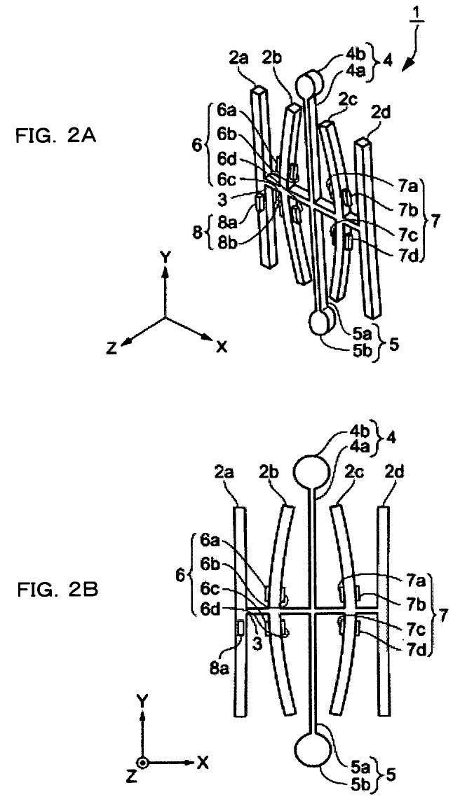

FIG. 1 is a schematic illustrating the construction of a vibrator of exemplary Embodiment 1. FIG. 2A is a schematic illustrating the vibrator of exemplary Embodiment 1 in the drive mode, and FIG. 2B is a front view of FIG. 2A.

As shown in FIG. 1, FIG. 2A and FIG. 2B, the vibrator 1 of exemplary Embodiment 1 has four vibrating bars, i.e., a vibrating bar (a first vibrating bar) 2a, a vibrating bar (a third vibrating bar) 2b, a vibrating bar (a fourth vibrating bar) 2c, a vibrating bar (a second vibrating bar) 2d, a beam 3, two supporting units 4 and 5, two driving units 6 and 7, and a detecting unit 8.

The vibrating bars 2a, 2b, 2c and 2d are bar-shaped members extending parallel to each other in the Y-direction, have a rectangular section, and are made of the same material. The vibrating bars 2b and 2c are provided between the vibrating bars 2a and 2d. Specifically, the vibrating bar 2b is provided at a position where the distance from vibrating bar 2b to the vibrating bar 2a is smaller than the distance from to the vibrating bar 2d, and the vibrating bar 2c is provided at a position where the distance from vibrating bar 2c to the vibrating bar 2d is smaller than the distance from to the vibrating bar 2a.

The vibrating bar 2a and the vibrating bar 2d are connected to the beam 3 at intersections 20 and 23 that are substantially the centers of their lengths. The vibrating bar 2a and the vibrating bar 2d do not vibrate in the drive mode at all.

The vibrating bar 2b intersects the beam 3 at an intersection 21 that is substantially the center of the length of vibrating bar 2b. The driving unit 6 is provided on two surfaces of the vibrating bar 2b parallel to the Y-Z plane, and includes driving elements 6a, 6b, 6c and 6d. The driving elements 6a and 6b are located at positions symmetrical with respect to a plane of the vibrating bar 2b parallel to the Y-Z plane. Similarly, the driving elements 6d and 6c are located at positions symmetrical with respect to a plane of the vibrating bar 2b parallel to the Y-Z plane.

The vibrating bar 2c intersects the beam 3 at an intersection 22 that is substantially the center of the length of vibrating bar 2c. The driving element 7 is provided on two surfaces of the vibrating bar 2c parallel to the Y-Z plane, and includes driving elements 7a, 7b, 7c and 7d. The driving elements 7a and 7b are located at positions symmetrical with respect to a plane of the vibrating bar 2c parallel to the Y-Z plane. Similarly, the driving elements 7d and 7c are located at positions symmetrical with respect to a plane of the vibrating bar 2c parallel to the Y-Z plane.

The beam 3 extends in the X-direction, is bar-shaped, and has a rectangular section. Also, the thickness of the beams 3 in the Z-direction is almost the same as the thickness of the vibrating bars 2a, 2b, 2c and 2d in the Z-direction. One end of the beam 3 is connected to the intersection 20 that is substantially the center of the length of the vibrating bar 2a, and the other end is connected to the intersection 23 that is substantially the center of the length of the vibrating bar 2d.

The supporting unit 4 includes a bar-shaped part 4a and a disc part 4b, and similarly, the supporting unit 5 includes a bar-shaped part 5a and a disc part 5b. The bar-shaped part 4a extends longer than the vibrating bars 2a, 2b, 2c and 2d in the Y-direction from substantially the center of the beam 3, and has a rectangular section. Further, the thickness of the bar-shaped part 4a min the Z-direction is almost the same as the thickness of the vibrating bars 2a, 2b, 2c and 2d and the beam 3 in the Z-direction. The disc part 4b is provided at the tip of the bar-shaped part 4a. The diameter of the disc part 4b is larger than the width the bar-shaped part 4a in the X-direction. Accordingly, the disc part 4b has an area necessary to fix the vibrator 1 to a circuit board or the like with an adhesive. Further, the thickness of the disc part 4b in the Z-direction is almost the same as the thickness of the bar-shaped part 4a in the Z-direction.

The bar-shaped part 5a and the disc part 5b have the same shape as the bar-shaped part 4a and the disc part 4b. The bar-shaped part 5a extends in a direction reverse to a direction in which the bar-shaped part 4a extends from substantially the center of the length of the beam 3, and the disc part 5b is provided at the tip of the bar-shaped part 5a.

The vibrating bar 2b performs bending vibration in the X-direction by the excitation of the driving unit 6 in the drive mode. It is noted that the intersection 21, where the vibrating bar 2b intersects the beam 3, becomes the center of the bending vibration of the vibrating bar 2b and thus does not move. Accordingly, the vibration of the vibrating bar 2b is not propagated to the beam 3.

Similarly, the vibrating bar 2c performs bending vibration in the X-direction by the excitation of the driving unit 7 in the driving mode. It is noted that the vibrating bar 2c is vibrated in anti-phase to the vibrating bar 2b. That is, as shown in FIG. 2A and FIG. 2B, when the vibrating bar 2b is deformed into a shape of the left arrow “<” in the X-direction, the vibrating bar 2c is deformed into a shape of the right arrow “>” opposite to the shape of the vibrating bar 2b. When the vibrating bar 2b is deformed into a shape of the right arrow “>” in the X-direction, the vibrating bar 2c is deformed into a shape of the left arrow “<” opposite to the shape of the vibrating bar 2b.

The intersection 22 where the vibrating bar 2c intersects the beams 3 becomes the center of the bending vibration of the vibrating bar 2c and thus does not move. Accordingly, the vibration of the vibrating bar 2c is not propagated to the beam 3.

The detecting unit 8 includes detecting elements 8a and 8b. The detecting elements 8a and 8b are provided to face two surfaces of the vibrating bar 2a, respectively, parallel to the X-Y plane. Also, the detecting elements 8a and 8b are attached to positions slightly deviated from substantially the center of the length of the vibrating bar 2a. The detecting unit 8 detects deformation caused in the vibrating bar 2a due to the detecting vibration of the vibrator 1 in the detecting mode.

In addition, the material for the vibrator can be appropriately selected out of a steady elastic material and a piezoelectric material. When a steady elastic material, such as an Elinvar material is used for the vibrator, a piezoelectric element, such as a piezo element is used as the driving element and the detecting element. Further, when a piezoelectric material, such as quartz crystal and lithium tantalate is used for the vibrator, an electrode may be used as the driving elements and the detecting elements.

Next, the detecting mode of the vibrator 1 in exemplary Embodiment 1 will be described.

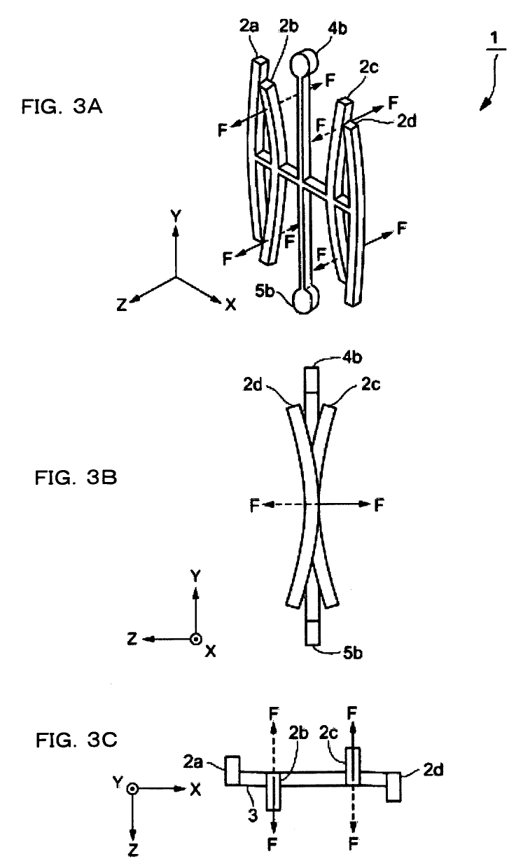

FIG. 3A, FIG. 3B and FIG. 3C are schematics illustrating a vibrator in the detecting mode. In the drive mode in which the vibrating bars 2b and 2c bendingly vibrate in the X-direction, when the vibrator 1 of exemplary Embodiment 1 rotates about the Y-direction as its central axis (referred to as “Y-axis rotation”), a Coriolis force F indicated by a solid line arrow along the Z-direction and a Coriolis force F indicated by a dotted line arrow along the Z-direction are alternately generated in the vibrating bars 2b and 2c. The alternately generated Coriolis forces cause the vibrating bars 2b and 2c to bendingly vibrate in the Z-direction. Specifically, while the vibrating bars 2b and 2c perform bending vibration in the X-direction, it simultaneously performs bending vibration in the Z-direction by Coriolis force. Further, the vibrating bars 2a and 2d vibrate to cancel an angular moment caused by the Coriolis forces F acting on the vibrating bars 2b and 2c. Specifically, the vibrating bars 2a and 2b and the vibrating bars 2c and 2d bendingly vibrate in the Z-direction so that they are respectively in anti-phase to each other.

Specifically, as shown in FIG. 3A, FIG. 3B and FIG. 3C, when a Coriolis force F indicated by the solid line arrow is generated, the vibrating bar 2a is deformed into a shape of the left arrow “<” in the Z-direction, and the vibrating bar 2b is deformed into a shape of the right arrow “>” opposite to the shape of the vibrating bar 2a. At this time, the vibrating bar 2d is deformed into a shape of the right arrow “>” opposite to the shape of the vibrating bar 2a, and the vibrating bar 2c is deformed into a shape of the left arrow “<” both opposite to the shape of the vibrating bar 2b and opposite to the shape of the vibrating bar 2d.

When a Coriolis force F indicated by the dotted arrow line is generated, the vibrating bar 2a is deformed into a shape of the right arrow “>” in the Z-direction, and the vibrating bar 2b is deformed into a shape of the left arrow “<” opposite to the shape of the vibrating bar 2a. At this time, the vibrating bar 2d is deformed into a shape of the left arrow “<” opposite to the shape of the vibrating bar 2a, and the vibrating bar 2c is deformed into a shape of the right arrow “>”, both opposite to the shape of the vibrating bar 2d and opposite to the shape of the vibrating bar 2b.

The bending vibration of the vibrating bars 2a, 2b, 2c and 2d along the Z-direction, specifically, the bending vibration of the vibrating bar 2a in the Z-direction, causes a change in the shape of the vibrating bar 2a at the position where the detecting unit 8 is attached. Since the detecting unit 8 has piezoelectricity, it generates electrical signals showing the change in the shape of the vibrating bar 2a and outputs the electrical signals to a calculating unit (not shown). When the calculating unit receives the electrical signals from the detecting unit 8, it processes the electrical signals in accordance with a related art method, thereby calculating the Y-axis rotation, that is to say, a change in the posture of the vibrator 1.

As described above, in the vibrator 1 of exemplary Embodiment 1, when the Y-axis rotation is generated during bending vibration of the vibrating bars 2b and 2c in the X-direction, a Coriolis force F in the Z-direction is caused in the vibrating bars 2b and 2c, and the vibrating bars 2b and 2c bendingly vibrate in the Z-direction by the Coriolis force F. The vibrating bars 2a and 2d bendingly vibrate in the Z-direction to cancel an angular moment caused by the bending vibration of the vibrating bars 2b and 2c. As a result, a change in shape is caused in the vibrating bar 2a by the bending vibration of the vibrating bar 2a itself. Accordingly, the detecting unit 8 provided in the vibrating bar 2a can detect the change in shape of the vibrating bar 2a. As a result, the Y-axis rotation of the vibrator 1 can be detected.

In the vibrator 1 of exemplary Embodiment 1, the Y-axis rotation of the vibrator 1 can also be detected similar to the above by providing the detecting unit 8 in the vibrating bar 2b, 2c or 2d. When the detecting unit 8 is provided in the vibrating bar 2a or 2d, erroneous detection caused by a leak of the vibration in the drive mode can be avoided. When the detecting unit 8 is provided in the vibrating bar 2b or 2c, a change in shape of a vibrating bar by a Coriolis force can be efficiently detected.

In the vibrator 1 of exemplary Embodiment 1, the vibrating bars 2a and 2d are located at positions symmetrical with respect to the Y-Z plane passing through the supporting units 4 and 5. The movement of the vibrating bar 2a has a relation of anti-phase with the movement of the vibrating bar 2d. Moreover, not only the supporting units 4 and 5 are located at positions equidistant from the vibrating bars 2a and 2d but also they are located at positions equidistant even from the vibrating bars 2b and 2c. Hence, the vibration of the vibrating bars 2a and 2b and the vibration of the vibrating bars 2c and 2d cancel each other. Specifically, leaking of the vibration of the vibrating bars 2a and 2b to the supporting units 4 and 5 and leaking of the vibration of the vibrating bars 2c and 2d to the supporting units 4 and can be canceled.

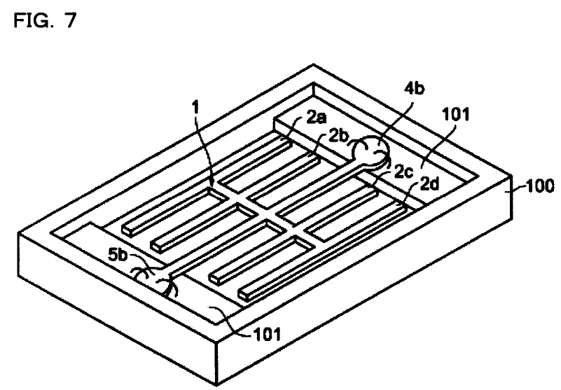

FIG. 7 is a schematic illustrating a state in which the above-mentioned vibrator 1 is mounted in a vibrator container.

The container 100 formed of ceramics is opened at one side to provide a recess. Further, the mount 101 is formed in the recess, and the vibrator 1 is fixed to the container by bonding the disc parts 4b and 5b of the supporting units 4 and 5 of the vibrator 1 to the mount 101 with an adhesive. In this case, the vibrating bars 2a, 2b, 2c and 2d of the vibrator 1 do not come in contact with the container 100, such that the vibration is not obstructed. Wire bonding is performed to connect wiring formed in the disc parts 4b and 5b of the supporting units to wiring formed in the container 100, such that electrical connection of the vibrator 1 and the container 100 is established. Also, a cover (not shown) is fixed to the top face of the container 100 to keep the inside of the container in a vacuum atmosphere or in an inert gas atmosphere, such that a packaged vibrator is formed. Modifications in Arrangement of Supporting Units

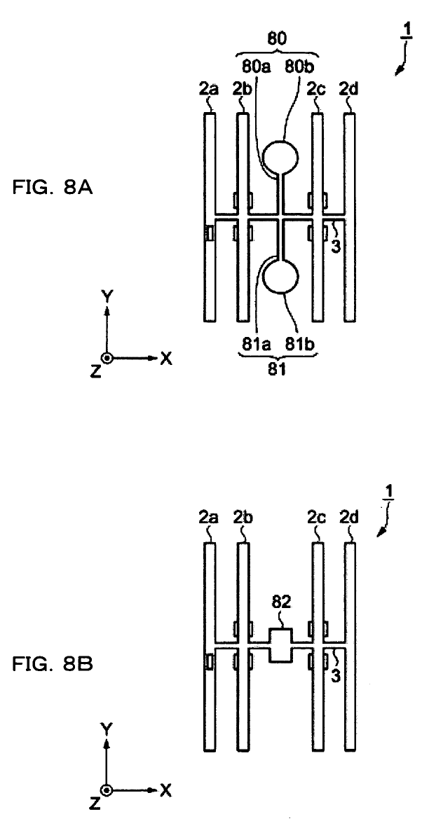

FIGS. 8A and B are schematics illustrating modifications in the arrangement of the supporting units of exemplary Embodiment 1.

As shown in FIG. 8A, bar-shaped parts 80a and 81a of supporting units 80 and 81 extend shorter than the length of the vibrating bars 2a, 2b, 2c and 2d. Disc parts 80b and 81b are formed at the tips of the supporting units 80 and 81. Also, the disc parts 80b and 81b are bonded to a container, such that the vibrator 1 can be fixed to the container.

Further, as shown in FIG. 8B, a supporting unit 82 may be provided in the vicinity of substantially the center of the length of the beam 3 connected to the vibrating bars 2a, 2b, 2c and 2d. Also, the supporting unit 82 is bonded to a container, such that the vibrator 1 can be fixed to the container.

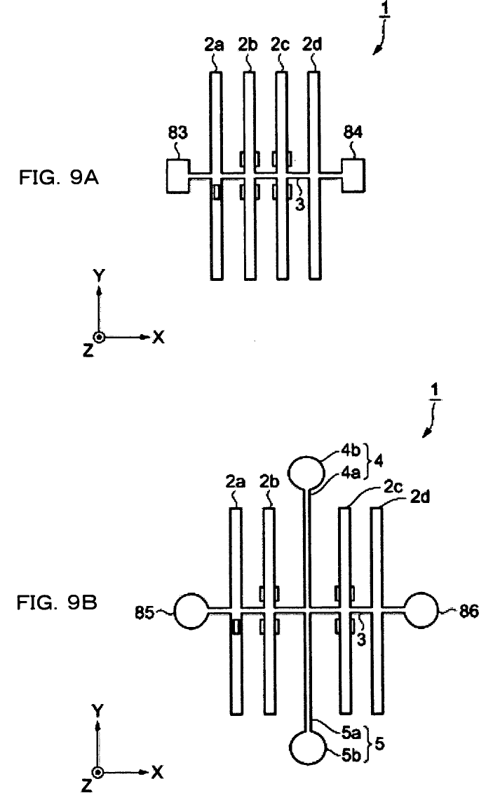

Further, other modifications shown in FIGS. 9A and 9B can also be made.

In FIG. 9A, supporting units 83 and 84 are provided at the tips of the beam 3 which extends outward from the vibrating bars 2a and 2d. Also, the supporting units 83 and 84 are bonded to a container, such that the vibrator 1 can be fixed to the container.

In FIG. 9B, disc parts 85 and 86 are supporting units provided at the tips of the beam 3 which extend outward from the vibrating bars 2a and 2d in addition to the supporting units 4 and 5 of exemplary Embodiment 1.

As described above, since the disc parts 4b, 5b, 85 and 86 can be bonded to a container, the bond strength of the vibrator 1 can be increased, and the impact resistance of the vibrator 1 can be enhanced. Further, since the wiring from a driving unit and a detecting unit is drawn out toward the supporting units 4, 5, 85 and 86, the degree of freedom of arrangement of wiring can be enhanced.

Modification of Detecting Mode

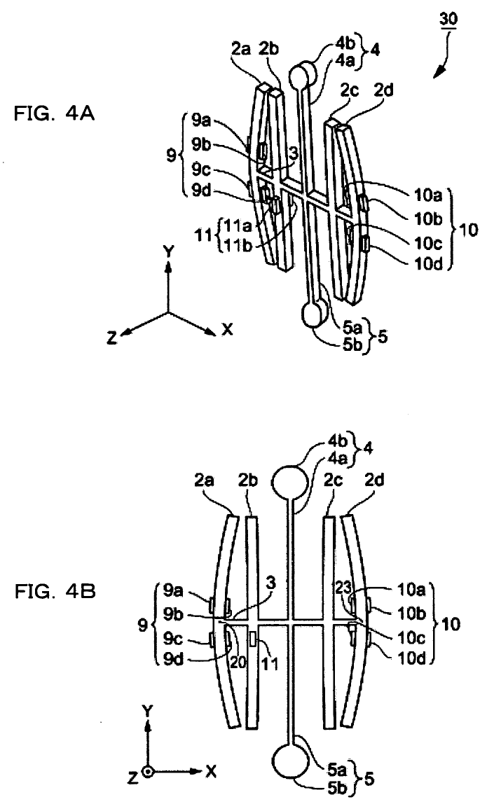

FIG. 4A and FIG. 4B are schematics illustrating a modification of the drive mode of a vibrator of exemplary Embodiment 1. A vibrator 30 provides driving units 9 and 10 in the vibrating bars 2a and 2d. The driving unit 9 includes driving elements 9a, 9b, 9c and 9d, and the driving unit 10 includes driving elements 10a, 10b, 10c and 10d. The positional relationship in the arrangement of these driving elements is similar to the positional relationship to the vibrating bars described in exemplary Embodiment 1.

Moreover, in the vibrator 30, a detecting element 11is provided in the vibrating bar 2b, and the detecting element 11 includes detecting elements 11a and 11b. The positional relationship of the detecting elements 11a and 11b is similar to the positional relationship to the vibrating bars described in exemplary Embodiment 1.

In the vibrator 30 constructed as above, the vibrating bars 2a and 2d bendingly vibrate in the X-direction in the drive mode, and the vibrating bars 2b and 2c do not bendingly vibrate at all.

Specifically, the vibrating bar 2a performs bending vibration along the X-direction by the excitation of the driving unit 9. Similarly, the vibrating bar 2d also performs bending vibration along the X-direction by the excitation of the driving unit 10. At this time, the vibrating bar 2a and the vibrating bar 2d perform bending vibration in anti-phase to each other. As shown in FIG. 4A and FIG. 4B, when the vibrating bar 2a is deformed into a shape of the left arrow “<” in the X-direction, the vibrating bar 2d is deformed into a shape of the right arrow “>” opposite to the shape of the vibrating bar 2a. Further, when the vibrating bar 2a is deformed into a shape of the right arrow “>” in the X-direction, the vibrating bar 2d is deformed into a shape of the left arrow “<” opposite to the shape of the vibrating bar 2a.

Since the intersection 20 that is a connecting point between the vibrating bar 2a and the beam 3 becomes the center of bending vibration of the vibrating bar 2a without movement, the vibration of the vibrating bar 2a is restrained from propagating to the beam 3. Similarly, since the intersection 23 that is a connecting point between the vibrating bar 2d and the beam 3 becomes the center of bending vibration of the vibrating bar 2d without movement, the vibration of the vibrating bar 2d is restrained from propagating to the beam 3.

In the vibrator 30, when the vibrating bars 2a and 2d bendingly vibrate in the X-direction in the drive mode, in case the Y-axis rotation is caused, the vibrating bars 2a and 2d bendingly vibrate in the Z-direction by a Coriolis force F generated along the Z-direction, similar to FIG. 3 illustrating the detecting mode of the vibrator 1. Further, the vibrating bars 2b and 2c bendingly vibrate in the Z-direction so that the vibration thereof is in anti-phase to the vibration of the vibrating bars 2a and 2d.

The bending vibration of the vibrating bars 2a, 2b, 2c and 2d along the Z-direction, specifically, the bending vibration of the vibrating bar 2b itself in the Z-direction, causes a change in the shape of the vibrating bar 2b at the position where the detecting unit 11 is attached. The detecting element 11 outputs electrical signals showing a change in the shape in the portion of the vibrating bar 2b to a calculating unit. The calculating unit calculates a change in the posture of the vibrator 30.

As described above, in the vibrator 30 of the modification, when the Y-axis rotation is generated during bending vibration of the vibrating bars 2a and 2d in the X-direction, a Coriolis force F in the Z-direction is caused in the vibrating bars 2b and 2c, such that the vibrating bars 2a and 2d bendingly vibrate in the Z-direction by the Coriolis force F while the vibrating bars 2b and 2c bendingly vibrate in the Z-direction, too. As a result, a change in shape is caused in the vibrating bar 2b by the bending vibration of the vibrating bar 2b itself. Accordingly, the detecting unit 11 provided in the vibrating bar 2b can detect the change in shape of the vibrating bar 2b. Specifically, the Y-axis rotation of the vibrator 30 can be detected.

The Y-axis rotation of the vibrator 30 can be detected similar to the above by providing the detecting unit 11 in the vibrating bar 2a, 2c or 2d not in the vibrating bar 2b. When the detecting unit 11 is provided in the vibrating bar 2b or 2c, erroneous detection caused by the leak of the vibration in the drive mode can be avoided. When the detecting unit 11 is provided in the vibrating bar 2a or 2d, a change in shape of a vibrating bar caused by a Coriolis force can be efficiently detected.

Modification Having a Plurality of Detecting Units Arranged Therein

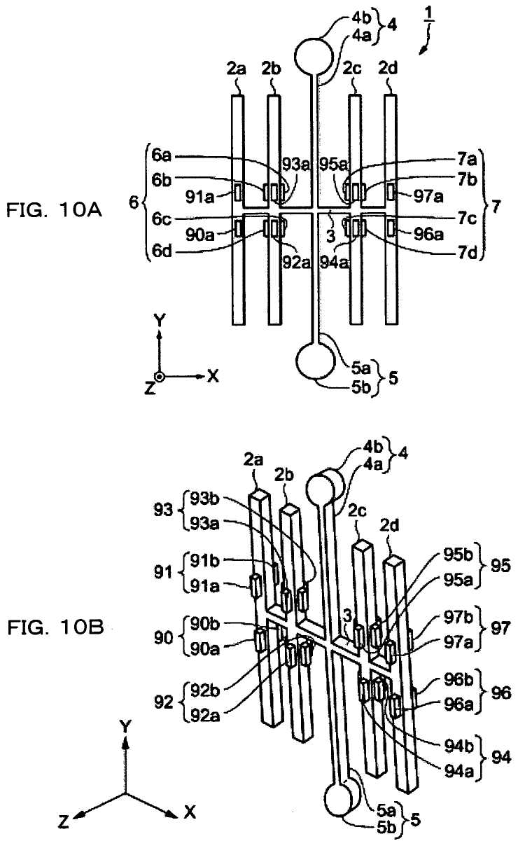

FIG. 10A is a schematic illustrating a modification when a plurality of detecting units is provided, and FIG. 10B is a schematic of FIG. 10A.

Detecting units 92 and 93 are provided in a vibrating bar 2b having a driving unit 6 including driving elements 6a, 6b, 6c and 6d. The detecting unit 92 includes detecting elements 92a and 92b provided on the X-Y plane with a mutual relation of the outside and inside in the vibrating bar 2b. Moreover, the detecting unit 93 includes detecting elements 93a and 93b provided on the X-Y plane with a mutual relation of the outside and inside in the vibrating bar 2b.

Similarly, detecting units 94 and 95 are provided in a vibrating bar 2c having a driving unit 7 including driving elements 7a, 7b, 7c and 7d. The detecting unit 94 includes detecting elements 94a and 94b, and the detecting unit 95 includes detecting elements 95a and 95b. In addition, the detecting units 92, 93, 94 and 95 are attached to positions slightly deviated from substantially the center of the length of the respective vibrating bars 2b and 2c.

The vibrating bar 2a is provided with detecting units 90 and 91. The detecting unit 90 includes detecting element 90a and 90b provided on the X-Y plane with a mutual relation of the outside and inside in the vibrating bar 2a. Moreover, the detecting unit 91 includes detecting element 91a and 91b provided on the X-Y plane with a mutual relation of the outside and inside in the vibrating bar 2a.

Similarly, the vibrating bar 2d is provided with the detecting units 96 and 97. The detecting unit 96 includes detecting element 96a and 96b, and the detecting unit 97 includes detecting element 97a and 97b. The detecting units 90 and 91 are attached to surfaces parallel to the X-Y plane slightly deviated from an intersection between the beam 3 and the vibrating bar 2a. The detecting units 96 and 97 are attached to planes parallel to the X-Y plane slightly deviated from an intersection of the beam 3 and the vibrating bar 2d.

The vibration of the respective vibrating bars 2a, 2b, 2c and 2d, which constitute the vibrator 1, in the drive mode and the detecting mode is the same as that described in exemplary Embodiment 1, so the description thereof will be omitted.

An effect obtained by providing a plurality of detecting units is that acceleration in the Z-direction that is a disturbance for the Y-axis rotation can be detected. When acceleration is applied in the Z-axis direction, four vibrating bars 2a, 2b, 2c and 2d are deformed in the same direction along the Z-axis. Hence, detecting units are provided in at least two vibrating bars that vibrate in anti-phase to each other along the Z-axis during the Y-axis rotation, such that the acceleration can be distinguished from the Y-axis rotation.

As described above, when driving units are provided in the vibrating bar 2b (the third vibrating bar) and the vibrating bar 2c (the fourth vibrating bar), and the vibrating bars 2b and 2c are driven so as to be in anti-phase to each other, as the arrangement of the detecting units which can detect acceleration in the Z-direction that is disturbance for the Y-axis rotation, any arrangement may be employed if detecting units are arranged at least two vibrating bars. The acceleration can be detected by selecting any one out of the following four types of arrangements:
arrangement of detecting units in the vibrating bar 2a (the first vibrating bar) and the vibrating bar 2d (the second vibrating bar);
arrangement of detecting units in the vibrating bar 2b (the third vibrating bar) and the vibrating bar 2c (the fourth vibrating bar);
arrangement of detecting units in the vibrating bar 2a (the first vibrating bar) and the vibrating bar 2b (the third vibrating bar); and
arrangement of detecting units in the vibrating bar 2c (the fourth vibrating bar) and the vibrating bar 2d (the second vibrating bar).

Further, when driving units are provided in the vibrating bar 2a (the first vibrating bar) and the vibrating bar 2d (the second vibrating bar), and the vibrating bars 2a and 2d are driven so as to be in anti-phase to each other, as in the arrangement of the detecting units which can detect acceleration in the Z-direction that is a disturbance for the Y-axis rotation, any arrangement may be employed if detecting units are arranged at at least two vibrating bars. The acceleration can be detected by selecting any one out of the following four types of arrangements:
arrangement of detecting units in the vibrating bar 2a (the first vibrating bar) and the vibrating bar 2d (the second vibrating bar);
arrangement of detecting units in the vibrating bar 2b (the third vibrating bar) and the vibrating bar 2c (the fourth vibrating bar);
arrangement of detecting units in the vibrating bar 2a (the first vibrating bar) and the vibrating bar 2b (the third vibrating bar); and
arrangement of detecting units in the vibrating bar 2c (the fourth vibrating bar) and the vibrating bar 2d (the second vibrating bar).

According to the above arrangement, the Y-axis rotation can be distinguished from acceleration, and the Y-axis rotation can be detected with high accuracy by canceling the acceleration.

Further, detecting units can be arranged in the portions of the vibrating bars where a Coriolis force causes any deformation. As shown in FIG. 10, a plurality of detecting units may be provided in one vibrating bar. As described above, an effect obtained by providing at least two detecting units is that the deformation of many vibrating bars is detected so that noises and errors in detection can be averaged in a calculating unit to detect the Y-axis rotation with high accuracy.

Exemplary Embodiment 2

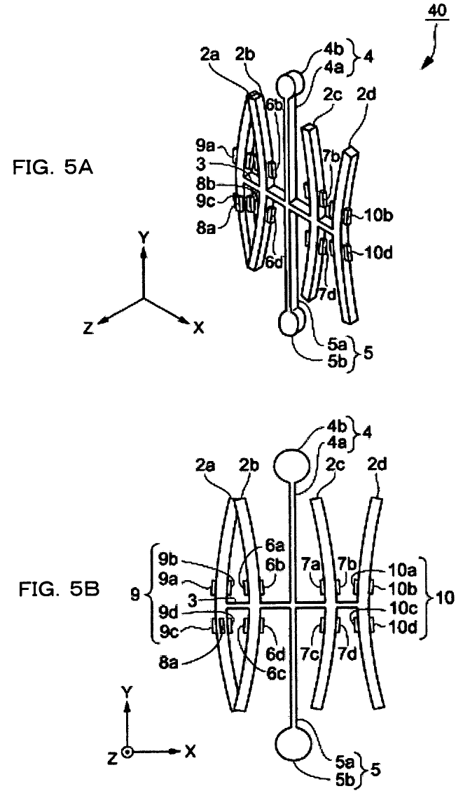

FIG. 5A and FIG. 5B are schematics illustrating a vibrator of exemplary Embodiment 2 during the drive mode.

A vibrator 40 of exemplary Embodiment 2 has a shape similar to the vibrator 1 of exemplary Embodiment 1. The vibrator 40 is different from the vibrator 1 in that driving units are provided in four vibrating bars and a detecting unit is provided in any one of those vibrating bars. Specifically, a driving unit 9 (9a, 9b, 9c and 9d) is provided in a vibrating bar 2a, a driving unit 6 (6a, 6b, 6c and 6d) is provided in a vibrating bar 2b, a driving unit 7 (7a, 7b, 7c and 7d) is provided in a vibrating bar 2c, and the driving unit 10 (10a, 10b 10c, and 10d) is provided in a vibrating bar 2d. Further, the vibrating bar 2a has a detecting unit 8 (8a and 8b). Hereinafter, the operation of the vibrator of exemplary Embodiment 2 in the drive mode and the detecting mode will be described.

As shown in FIG. 5A and FIG. 5B, in the vibrator 40 of exemplary Embodiment 2, the vibrating bars 2a and 2b bendingly vibrate in anti-phase to each other in the X-direction in the driving mode, and the vibrating bars 2c and 2d bendingly vibrate in anti-phase to each other in the X-direction. The bending vibration of the vibrating bar 2a and the bending vibration of the vibrating bar 2d have a relation in-phase to each other. Further, the bending vibration of the vibrating bar 2b and the bending vibration of the vibrating bar 2c have a relation in-phase to each other.

Specifically, when the vibrating bar 2a is deformed into a shape of the left arrow “<” in the X-direction, the vibrating bar 2b is deformed into a shape of the right arrow “>” opposite to the shape of the vibrating bar 2a. At this time, the vibrating bar 2d is deformed into a shape of the left arrow “<” substantially identical to a shape of the vibrating bar 2a, and the vibrating bar 2c is deformed into a shape of the right arrow “>” opposite to the shape of the vibrating bar 2d and substantially identical to a shape of the vibrating bar 2b.

When the vibrating bar 2a is deformed into a shape of the right arrow “>” in the X-direction, the vibrating bar 2b is deformed into a shape of the left arrow “<” opposite to the shape of the vibrating bar 2a. At this time, the vibrating bar 2d is deformed into a shape of the right arrow “>” substantially identical to a shape of the vibrating bar 2a. The vibrating bar 2c is deformed into a shape of the left arrow “<” opposite to the shape of the vibrating bar 2d and substantially identical to a shape of the vibrating bar 2b.

Next, the detecting mode of the vibrator 40 of exemplary Embodiment 2 will be described.

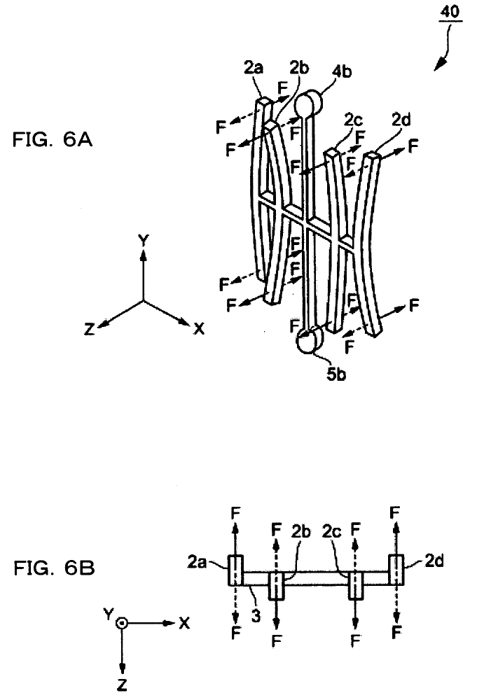

FIG. 6A and FIG. 6B are schematics illustrating a vibrator of exemplary Embodiment 2 in the detecting mode. In the vibrator 40 of exemplary Embodiment 2, at the time of the detecting mode, specifically, when the Y-axis rotation is caused during bending vibration along the X-direction in the above-described drive mode, a Coriolis force F in the Z-direction indicated by the solid line arrow, and a Coriolis force F indicated in the Z-direction by the dotted line arrow are alternately generated. At this time, the vibrating bars 2a and 2b bendingly vibrate in anti-phase to each other in the Z-direction, and the vibrating bars 2c and 2d bendingly vibrate in anti-phase relation to each other in the Z-direction, also. The vibrating bars 2a and 2d bendingly vibrate in phase to each other in the Z-direction, and the vibrating bars 2b and 2c bendingly vibrate in phase to each other in the Z-direction, also.

Specifically, when a Coriolis force F indicated by the solid line arrow is generated, the vibrating bar 2a is deformed into a shape of the left arrow “<” in the Z-direction, and the vibrating bar 2b is deformed into a shape of the right arrow “>” opposite to the shape of the vibrating bar 2a. At this time, the vibrating bar 2d is deformed into a shape of the left arrow “<” substantially identical to a shape of the vibrating bar 2a. The vibrating bar 2c is deformed into a shape of the right arrow “>” opposite to the shape of the vibrating bar 2d and substantially identical to a shape of the vibrating bar 2b.

When a Coriolis force F indicated by the dotted arrow line is generated, the vibrating bar 2a is deformed into a shape of the right arrow “>” in the Z-direction, and the vibrating bar 2b is deformed into a shape of the left arrow “<” opposite to the shape of the vibrating bar 2a. At this time, the vibrating bar 2d is deformed into a shape of the right arrow “>” substantially identical to a shape of the vibrating bar 2a. The vibrating bar 2c is deformed into a shape of the left arrow “<” opposite to the shape of the vibrating bar 2d and substantially identical to a shape of the vibrating bar 2b.

Such bending vibration of the vibrating bars 2a, 2b, 2c and 2d of the Z-direction in the detecting mode, specifically, the bending vibration of the vibrating bar 2a itself in the Z-direction, causes a change in shape of the vibrating bar 2a. The detecting unit 8 (8a and 8b) provided in the vibrating bar 2a detects the change in shape of the vibrating bar 2a. As a result, a calculating unit can calculate a change in the posture of the vibrator 40.

As described above, in the vibrator 40 of exemplary Embodiment 2, a Coriolis force F in the Z-direction generated corresponding to the Y-axis rotation causes the vibrating bars 2a and 2b to bendingly vibrate in anti-phase to each other in the Z-direction, and the vibrating bars 2c and 2d to bendingly vibrate in anti-phase to each other in the Z-direction, too. The vibrating bars 2a and 2d bendingly vibrate in phase to each other, and the vibrating bars 2b and 2c bendingly vibrate in phase to each other, also. The bending vibration of the vibrating bar 2a causes a change in shape of the vibrating bar 2a. The detecting unit 8 provided in the vibrating bar 2a can detect the Y-axis rotation of the vibrator 40 by detecting the change in shape of the vibrating bar 2a.

Instead of providing the detecting unit 8 in the vibrating bar 2a in the vibrator 40 of exemplary Embodiment 2, the Y-axis rotation of the vibrator 40 can be detected similarly by providing the detecting unit 8 in the vibrating bar 2b, the vibrating bar 2c, or the vibrating bar 2d.

Modification of Detecting Mode

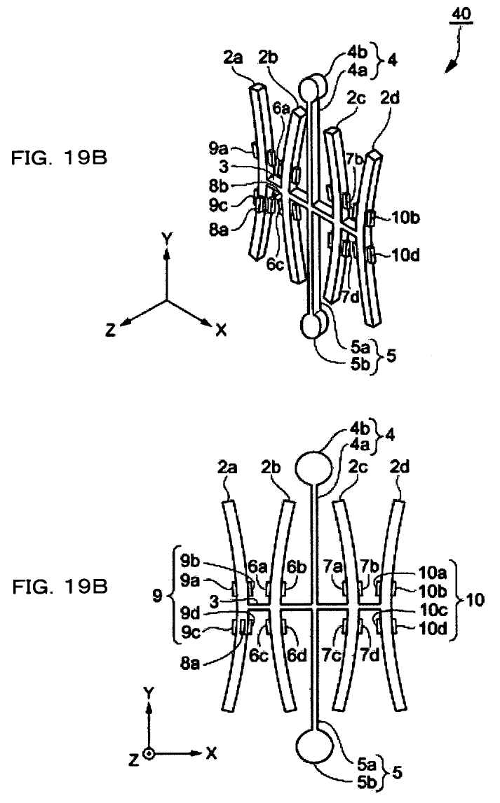

FIG. 19A and FIG. 19B are schematics illustrating a modification of the vibrator of exemplary Embodiment 1 in the drive mode. Since the construction of the vibrator 40 is similar to that of exemplary Embodiment 2, the same reference numerals is given to the drawings, and the description thereof will be omitted. Hereinafter, the operation of the vibrator of a modification of exemplary Embodiment 2 in the drive mode and the detecting mode will be described.

As shown in FIG. 19A and FIG. 19B, in the driving mode of the vibrator 40, the vibrating bars 2a and 2b bendingly vibrate in anti-phase to each other in the X-direction. The vibrating bars 2c and 2d bendingly vibrate in anti-phase to each other in the X-direction. In addition, the bending vibration of the vibrating bar 2a and the bending vibration of the vibrating bar 2d have a relation of anti-phase to each other. Further, the bending vibration of the vibrating bar 2b and the bending vibration of the vibrating bar 2c have a relation of anti-phase to each other.

Specifically, when the vibrating bar 2a is deformed into a shape of the right arrow “>” in the X-direction, the vibrating bar 2b is deformed into a shape of the left arrow “<” opposite to the shape of the vibrating bar 2a. At this time, the vibrating bar 2c is deformed into a shape of the right arrow “>” substantially identical to a shape of the vibrating bar 2a, and the vibrating bar 2d is deformed into a shape of the left arrow “<” opposite to the shape of the vibrating bar 2c and substantially identical to the shape of the vibrating bar 2b.

When the vibrating bar 2a is deformed into a shape of the left arrow “<” in the X-direction, the vibrating bar 2b is deformed into a shape of the right arrow “>” opposite to the shape of the vibrating bar 2a. At this time, the vibrating bar 2c is deformed into a shape of the left arrow “<” substantially identical to a shape of the vibrating bar 2a, and the vibrating bar 2d is deformed into a shape of the right arrow “>” opposite to the shape of the vibrating bar 2c and substantially identical to a shape of the vibrating bar 2b.

Next, the detecting mode of the vibrator 40 will be described.

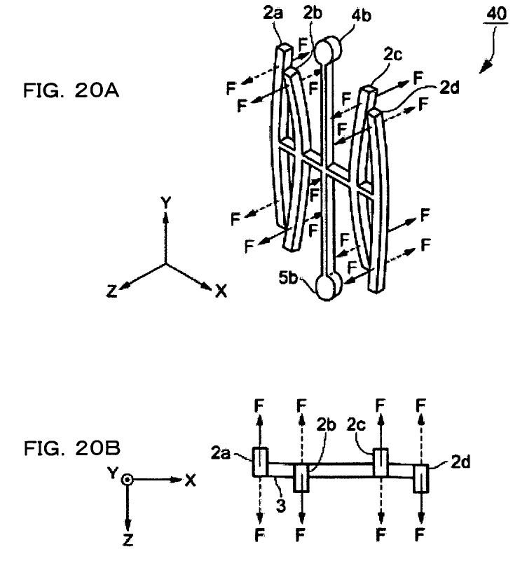

FIG. 20A and FIG. 20B are schematics illustrating a vibrator in the detecting mode. In the vibrator 40, at the time of the detecting mode, specifically, when the Y-axis rotation is caused during bending vibration along the X-direction, a Coriolis force F in the Z-direction indicated by the solid line arrow and a Coriolis force F indicated in the Z-direction by the dotted line arrow are alternately generated. At this time, the vibrating bars 2a and 2b bendingly vibrate in anti-phase to each other in the Z-direction, and the vibrating bars 2c and 2d bendingly vibrate in anti-phase relation to each other in the Z-direction, too. The vibrating bars 2a and 2d bendingly vibrate in anti-phase to each other in the Z-direction, and the vibrating bars 2b and 2c bendingly vibrate in anti-phase to each other in the Z-direction, also.

Specifically, when a Coriolis force F indicated by the solid line arrow is generated, the vibrating bar 2a is deformed into a shape of the left arrow “<” in the Z-direction, and the vibrating bar 2b is deformed into a shape of the right arrow “>” opposite to the shape of the vibrating bar 2a. At this time, the vibrating bar 2c is deformed into a shape of the left arrow “<” substantially identical to a shape of the vibrating bar 2a. The vibrating bar 2d is deformed into a shape of the right arrow “>” opposite to the shape of the vibrating bar 2c and substantially identical to a shape of the vibrating bar 2b.

When a Coriolis force F indicated by the dotted arrow line is generated, the vibrating bar 2a is deformed into a shape of the right arrow “>” in the Z-direction, and the vibrating bar 2b is deformed into a shape of the left arrow “<” opposite to the shape of the vibrating bar 2a. Further, the vibrating bar 2c is deformed into a shape of the right arrow “>” substantially identical to a shape of the vibrating bar 2a. The vibrating bar 2d is deformed into a shape of the left arrow “<” opposite to the shape of the vibrating bar 2c and substantially identical to a shape of the vibrating bar 2b.

Such bending vibration of the vibrating bars 2a, 2b, 2c and 2d in the Z-direction in the detecting mode, specifically, the bending vibration of the vibrating bar 2a itself in the Z-direction causes a change in shape of the vibrating bar 2a. The detecting unit 8 (8a and 8b) provided in the vibrating bar 2a detects the change in shape of the vibrating bar 2a. As a result, a calculating unit can calculate a change in the posture of the vibrator 40. Modification Having a Plurality of Detecting Units Arranged Therein

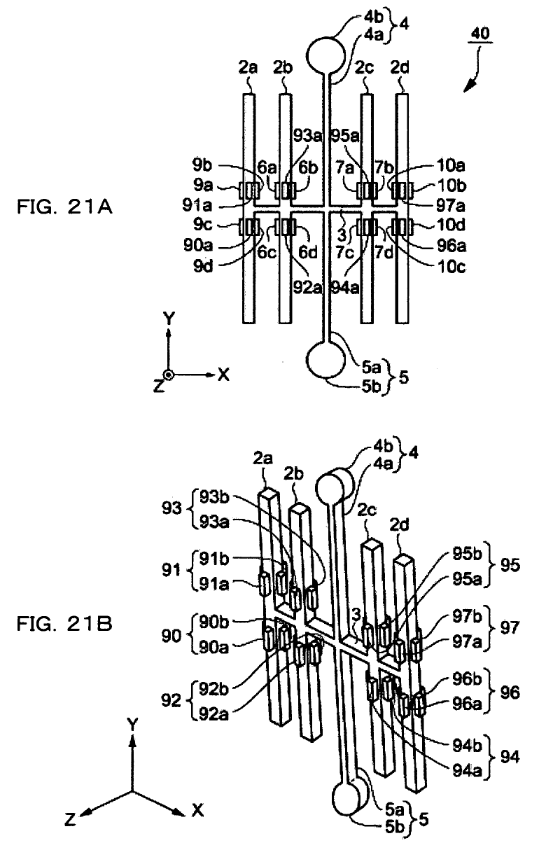

FIGS. 21A and 21B are schematics illustrating a modification when a plurality of detecting units is provided.

A vibrating bar 2a has a driving unit 9 including driving elements 9a, 9b, 9c and 9d, and a detecting unit 90 including detecting elements 90a and 90b and a detecting unit 91 including detecting elements 91a and 91b.

Further, a vibrating bar 2b has a driving unit 6 including driving elements 6a, 6b, 6c and 6d, a detecting unit 92 including detecting elements 92a and 92b and a detecting unit 93 including detecting elements 93a and 93b.

Also, the vibrating bar 2c has a driving unit 7 including the driving elements 7a, 7b, 7c and 7d, a detecting unit 94 including detecting elements 94a and 94b and a detecting unit 95 including detecting elements 95a and 95b.

Moreover, a vibrating bar 2d has a driving unit 10 including driving elements 10a, 10b, 10c and 10d, a detecting unit 96 including detecting elements 96a and 96b and a detecting unit 97 including detecting elements 97a and 97b.

The driving elements of the driving units 6, 7, 9 and 10 are provided opposite to each other on the Y-Z planes of the respective vibrating bars, and they are attached to positions slightly deviated from substantially the center of the length of the vibrating bars.

Further, the detecting elements of the detecting units 90, 91, 92, 93, 94, 95, 96 and 97 are provided opposite to each other on the X-Y planes of the respective vibrating bars, and they are attached to positions slightly deviated from substantially the center of the length of the vibrating bars.

The vibration of the respective vibrating bars 2a, 2b, 2c and 2d, which constitute the vibrator 40, in the drive mode and the detecting mode, has already been described in exemplary Embodiment 2 and the modification thereof, so the description thereof will be omitted.

An effect obtained by providing a plurality of detecting units is that acceleration in the Z-direction that is disturbance for the Y-axis rotation can be detected. When acceleration is applied in the Z-axis direction, four vibrating bars 2a, 2b, 2c and 2d are deformed in the same direction along the Z-axis. From the foregoing, detecting units are provided in at least two vibrating bars that vibrate in anti-phase to each other along the Z-axis during the Y-axis rotation, such that the acceleration can be distinguished from the Y-axis rotation.

When the vibrating bars are driven such that the vibrations of the vibrating bar 2a (the first vibrating bar) and the vibrating bar 2d (the second vibrating bar) are in phase to each other, the vibrations of the vibrating bar 2b (the third vibrating bar) and the vibrating bar 2c (the fourth vibrating bar) are in phase to each other, and the vibrations of the vibrating bar 2a and the vibrating bar 2b are in anti-phase to each other, acceleration can be detected by selecting any one of four kinds of the following arrangements as the arrangement of the detecting unit which can detect acceleration of the Z-direction which is disturbance for the Y-axis rotation.

Arrangement of detecting units in the vibrating bar 2a (the first vibrating bar) and the vibrating bar 2c (the fourth vibrating bar);
arrangement of detecting units in the vibrating bar 2b (the third vibrating bar) and the vibrating bar 2d (the second vibrating bar);
arrangement of detecting units in the vibrating bar 2a (the first vibrating bar) and the vibrating bar 2b (the third vibrating bar); and
arrangement of detecting units in the vibrating bar 2c (the fourth vibrating bar) and the vibrating bar 2d (the second vibrating bar).

Further, when the vibrating bars are driven such that the vibrations of the vibrating bar 2a (the first vibrating bar) and the vibrating bar 2d (the second vibrating bar) are in anti-phase to each other, the vibrations of the vibrating bar 2b (the third vibrating bar) and the vibrating bar 2c (the fourth vibrating bar) are in anti-phase to each other, and the vibrations of the vibrating bar 2a and the vibrating bar 2b are in anti-phase to each other, acceleration can be detected by selecting any one of four kinds of the following arrangements as the arrangement of the detecting unit which can detect acceleration of the Z-direction which is disturbance for the Y-axis rotation.

Arrangement of detecting units in the vibrating bar 2a (the first vibrating bar) and the vibrating bar 2d (the second vibrating bar);
arrangement of detecting units in the vibrating bar 2a (the first vibrating bar) and the vibrating bar 2b (the third vibrating bar);
arrangement of detecting units in the vibrating bar 2c (the fourth vibrating bar) and the vibrating bar 2d (the second vibrating bar); and
arrangement of detecting units in the vibrating bar 2b (the third vibrating bar) and the vibrating bar 2c (the fourth vibrating bar).

As described above, detecting units are provided in at least two vibrating bars in anti-phase to each other, such that the Y-axis rotation can be distinguished from the acceleration and the Y-axis rotation can be detected with high accuracy.

Further, detecting units can be arranged in the portions of the vibrating bars where a Coriolis force causes any deformation. As shown in FIG. 21, a plurality of detecting units may be provided in one vibrating bar. As described above, an effect obtained by providing at least two detecting units is that the deformation of many vibrating bars is detected, such that noises and errors in detection can be averaged in a calculating unit to detect the Y-axis rotation with high accuracy.

Exemplary Embodiment 3

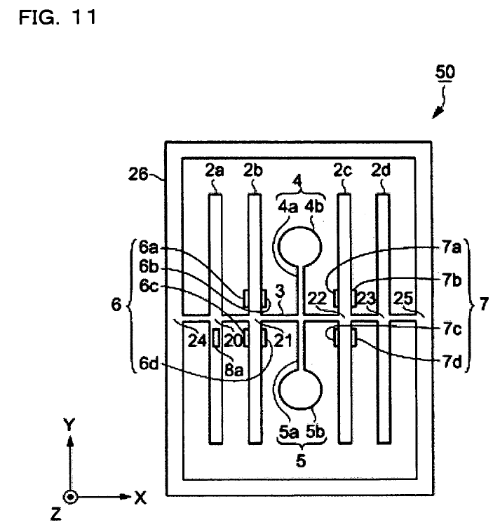

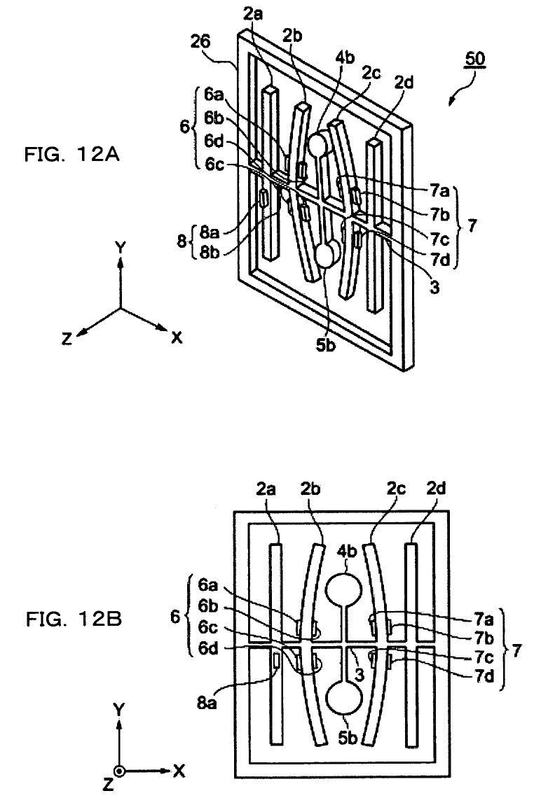

FIG. 11 is a schematic illustrating the construction of a vibrator of exemplary Embodiment 3, and FIG. 12A and FIG. 12B are schematics illustrating a vibrator of exemplary Embodiment 3 in the drive mode. The vibrator 50 of exemplary Embodiment 3 has four vibrating bars, i.e., a vibrating bar 2a (a first vibrating bar), a vibrating bar 2b (a third vibrating bar), a vibrating bar 2c (a fourth vibrating bar), a vibrating bar 2d (a second vibrating bar), a beam 3, two supporting units 4 and 5, a frame member 26, two driving units 6 and 7, and a detecting unit 8, in order to detect the Y-axis rotation.

The vibrating bars 2a, 2b, 2c and 2d are bar-shaped members extending parallel to each other in the Y-direction, have a rectangular section, and are made of the same material. The vibrating bars 2b and 2c are provided between the vibrating bars 2a and 2d. Specifically, the vibrating bar 2b is provided at a position where the distance from vibrating bar 2b to the vibrating bar 2a is smaller than the distance from vibrating bar 2b to the vibrating bar 2d, and the vibrating bar 2c is provided at a position where the distance from vibrating bar 2c to the vibrating bar 2d is smaller than the distance from vibrating bar 2c to the vibrating bar 2a.

The vibrating bar 2a and the vibrating bar 2d are connected to the beam 3 at intersections 20 and 23 that are substantially the centers of the lengths of vibrating bar 2a and vibrating bar 2d. The vibrating bar 2a and the vibrating bar 2d do not vibrate in the drive mode at all.

The vibrating bar 2b intersects the beam 3 at an intersection 21 that is substantially the center of the length of vibrating bar 2b. The driving unit 6 is provided on two surfaces parallel to the Y-Z plane of the vibrating bar 2b. The driving unit 6 includes driving elements 6a, 6b, 6c and 6d, and the driving elements 6a and 6b are located at the positions which are symmetrical with respect to planes of the vibrating bar 2b parallel to the Y-Z plane. Similarly, the driving elements 6c and 6d are located at the positions symmetrical with respect to the Y-Z plane. The vibrating bar 2c intersects the beam 3 at an intersection 22 that is substantially the center of the length thereof.

The driving unit 7 is provided on two surfaces of the vibrating bar 2c parallel to the Y-Z plane, and includes driving elements 7a, 7b, 7c and 7d. The driving elements 7a and 7b are located at positions symmetrical with respect to a plane of the vibrating bar 2c parallel to the Y-Z plane. Similarly, the driving elements 7c and 7d are located at the positions symmetrical with respect to the Y-Z plane.

The beam 3 is a bar-shaped member extending in the X-direction, and has a rectangular section. The thickness of the beam 3 in the Z-direction is almost the same as the thickness of the vibrating bars 2a, 2b, 2c and 2d in the Z-direction. One end of the beam 3 is connected to the intersection 20 which is substantially the center of the vibrating bar 2a. The other end of beam 3 is connected to the intersection 23 which is substantially the center of the vibrating bar 2d.

Further, the beam 3 extends in the X-direction from the intersections 20 and 23 which are substantially the centers of the vibrating bars 2a and 2b, and is connected to the frame member 26 surrounding the vibrating bars 2a, 2b, 2c and 2d from the outside at intersections 24 and 25. The frame member 26 has a rectangular section. The thickness of the frame member 26 in the Z-direction is almost the same as the thickness of the vibrating bars 2a, 2b, 2c and 2d in the Z-direction.

The supporting unit 4 includes a bar-shaped part 4a and a disc part 4b. Similarly, the supporting unit 5 includes a bar-shaped part 5a and a disc part 5b. The bar-shaped part 4a extends in the Y-direction from substantially the center of the length of the beam 3, and has a rectangular section. The thickness of bar-shaped part 4a in the Z-direction is almost the same as the thickness of the vibrating bars 2a, 2b, 2c and 2d and the beam 3 in the Z-direction. The disc part 4b is provided at the tip of the bar-shaped part 4a. The diameter of the disc part 4b is larger than the width of the bar-shaped part 4a in the X-direction. Accordingly, the disc part 4b has an area necessary to fix the vibrator 50 to a circuit board or the like with an adhesive. Further, the thickness of the disc part 4b in the Z-direction is almost the same as the thickness of the bar-shaped part 4a in the Z-direction.

The bar-shaped part 5a and the disc part 5b have a shape similar to the bar-shaped part 4a and the disc part 4b. The bar-shaped part 5a extends from substantially the center of the length of the beam 3 along the Y-direction in a direction reverse to the direction in which the bar-shaped part 4a extends. The disc part 5b is provided at the tip of the bar-shaped part 5a.

The vibrating bar 2b performs bending vibration to detect the Y-axis rotation along the X-direction by the excitation of the driving unit 6 in the driving mode. It is noted that, since the intersection 21 where the vibrating bar 2b intersects the beam 3 becomes the center of bending vibration of the vibrating bar 2b without movement, the vibration of the vibrating bar 2b is restrained from propagating to the beam 3.

The vibrating bar 2c performs bending vibration along the X-direction similar to the vibrating bar 2b in anti-phase to the vibrating bar 2b by the excitation of the driving element 7. As shown in FIG. 12A and FIG. 12B, when the vibrating bar 2b is deformed into a shape of the left arrow “<” in the X-direction, the vibrating bar 2c is deformed into a shape of the right arrow “>” opposite to the shape of the vibrating bar 2b. When the vibrating bar 2b is deformed into a shape of the right arrow “>” in the X-direction, the vibrating bar 2c is deformed into a shape of the left arrow “<” opposite to the shape of the vibrating bar 2b. Since the intersection 22 where the vibrating bar 2c intersects the beam 3 becomes the center of bending vibration of the vibrating bar 2c without movement, the vibration of the vibrating bar 2c is restrained from propagating to the beam 3.

The detecting unit 8 includes the detecting elements 8a and 8b. The detecting elements 8a and 8b are attached to positions slightly deviated from the center of the length in the X-Y plane with a mutual relation of the outside and inside in the vibrating bar 2a. The detecting unit 8 outputs electrical signals showing the extent of deformation and displacement caused in the vibrating bar 2a.

The material for the vibrator can be appropriately selected out of a steady elastic material and a piezoelectric material. When a steady elastic material, such as an Elinvar material, is used, a piezoelectric element, such as a piezo element, is used as the driving elements and the detecting elements. Further, when a piezoelectric material, such as quartz crystal and lithium tantalite, is used for the vibrator, an electrode may be used as the driving elements and the detecting elements.

Next, the detecting mode of the vibrator 50 in exemplary Embodiment 3 will be described.

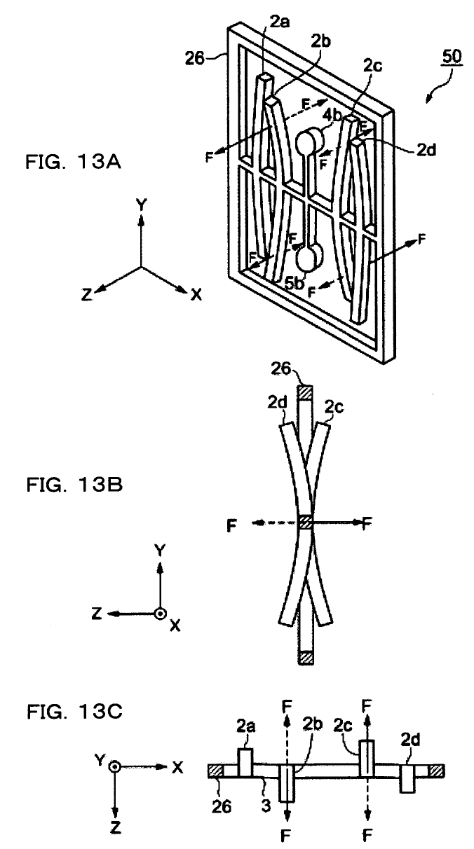

FIG. 13A, FIG. 13B and FIG. 13C are schematics illustrating the vibrator 50 in the detecting mode. In the drive mode in which the vibrating bars 2b and 2c bendingly vibrate in the X-direction, when the vibrator 50 of exemplary Embodiment 3 rotates about the Y-axis, a Coriolis force F indicated by the solid line arrow along the Z-direction and a Coriolis force F indicated by the dotted line arrow along the Z-direction are alternately generated in the vibrating bars 2b and 2c. The alternately generated Coriolis forces cause the vibrating bars 2b and 2c to bendingly vibrate in the Z-direction. Further, the vibrating bars 2a and 2d bendingly vibrate along the Z-direction so that the movement thereof cancels an angular moment caused by a Coriolis force F acting on the vibrating bars 2b and 2c, specifically, in anti-phase to the movement of the vibrating bar 2b and 2c.

Specifically, as shown in FIG. 13A, FIG. 13B and FIG. 13C, when a Coriolis force F indicated by the solid line arrow is generated, the vibrating bar 2a is deformed into a shape of the left arrow “<” in the Z-direction, and the vibrating bar 2b is deformed into a shape of the right arrow “>” opposite to the shape of the vibrating bar 2a. At this time, the vibrating bar 2d is deformed into a shape of the right arrow “>” opposite to the shape of the vibrating bar 2a, and the vibrating bar 2c is deformed into a shape of the left arrow “<” both opposite to the shape of the vibrating bar 2 and opposite to the shape of the vibrating bar 2b.

When a Coriolis force F indicated by the dotted arrow line is generated, the vibrating bar 2a is deformed into a shape of the right arrow “>” in the Z-direction, and the vibrating bar 2b is deformed into a shape of the left arrow “<” opposite to the shape of the vibrating bar 2a. At this time, the vibrating bar 2d is deformed into a shape of the left arrow “<” opposite to the shape of the vibrating bar 2a, and the vibrating bar 2c is deformed into a shape of the right arrow “>” both opposite to the shape of the vibrating bar 2d and opposite to the shape of the vibrating bar 2b.

The bending vibration of the vibrating bars 2a, 2b, 2c and 2d along the Z-direction, specifically, the bending vibration of the vibrating bar 2a itself in the Z-direction causes a change in the shape of the vibrating bar 2a at the position where the detecting unit 8 is attached. Since the detecting unit 8 has piezoelectricity, it generates electrical signals showing the change in the shape of the vibrating bar 2a and outputs the electrical signals to a calculating unit (not shown). When the calculating unit receives the electrical signals from the detecting unit 8, it processes the electrical signals in accordance with a related art method, thereby calculating the Y-axis rotation, that is to say, a change in the posture of the vibrator 1.

As described above, in the vibrator 50 of exemplary Embodiment 3, when the Y-axis rotation is generated during bending vibration of the vibrating bars 2b and 2c in the X-direction, a Coriolis force F in the Z-direction is caused in the vibrating bars 2b and 2c, and the vibrating bars 2b and 2c bendingly vibrate in the Z-direction by the Coriolis force F. The vibrating bars 2a and 2d vibrate along the Z-direction to cancel an angular moment caused by the bending vibration of the vibrating bars 2b and 2c. As a result, a change in shape is caused in the vibrating bar 2a by the bending vibration of the vibrating bar 2a itself. Accordingly, the detecting unit 8 provided in the vibrating bar 2a can detect the change in shape of the vibrating bar 2a such that it can detect the Y-axis rotation of the vibrator 50.

In the vibrator 50 of exemplary Embodiment 3, the Y-axis rotation of the vibrator 50 can also be detected similar to the above by providing the detecting unit 8 in the vibrating bar 2b, 2c or 2d. When the detecting unit 8 is provided in the vibrating bar 2a or 2d, erroneous detection caused by the leak of the vibration in the drive mode can be avoided. When the detecting unit 8 is provided in the vibrating 2b or 2c, a change in shape of a vibrating bar by a Coriolis force can be efficiently detected.

In the vibrator 50 of exemplary Embodiment 3, the vibrating bars 2a and 2d are located at positions symmetrical with respect to the Y-Z plane passing through the supporting units 4 and 5, and the movement of the vibrating bar 2a has a relation of anti-phase with the movement of the vibrating bar 2d. Moreover, not only the supporting units 4 and 5 are located at positions equidistant from the vibrating bars 2a and 2d but also they are located at positions equidistant from the vibrating bars 2b and 2c. From the foregoing, the vibration of the vibrating bars 2a and 2b and the vibration of the vibrating bars 2c and 2d cancel each other. Leaking of the vibration of the vibrating bars 2a and 2b to the supporting units 4 and 5 and leaking of the vibration of the vibrating bars 2c and 2d to the supporting units 4 and 5 can be canceled. Further, the frame member 26 is provided as in the vibrator 50 so that the wiring from a driving unit and a detecting unit is drawn out toward the frame member 26, resulting in the enhancement of the degree of freedom in arrangement of wiring.

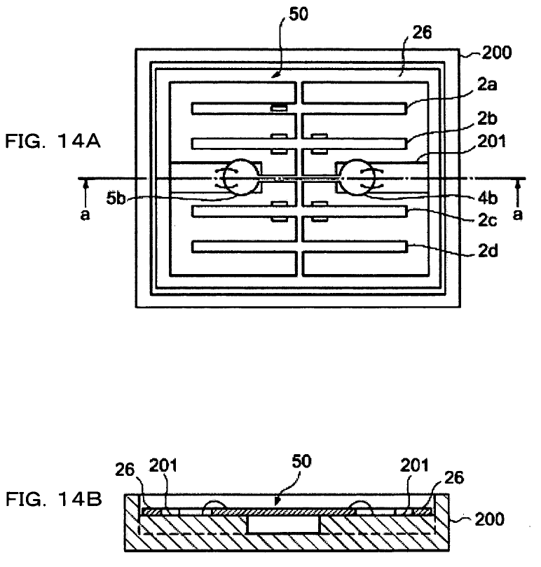

FIG. 14A is a schematic illustrating a state in which the above-mentioned vibrator 50 is mounted in a vibrator container. FIG. 14B is a schematic taken along the plane a-a of FIG. 14A.

The container 200 formed of ceramics is opened at one side to provide a recess. Further, the mount 201 is formed in the recess, and the vibrator 50 is fixed to the container by bonding the disc parts 4b and 5b of the supporting units 4 and 5 and the frame member 26 of the vibrator 50 to the mount 201 with an adhesive. At this time, the vibrating bars 2a, 2b, 2c and 2d of the vibrator 50 do not come in contact with the container 200 and do not obstruct the vibration. Wire bonding is performed to connect wiring formed in the disc parts 4b and 5b of the supporting units to wiring formed in the container 200, such that electrical connection of the vibrator 50 and the container 200 is established. Also, a cover (not shown) is fixed to the top face of the container 200 to keep the inside of the container in a vacuum atmosphere or in an inert gas atmosphere, such that a packaged vibrator is formed.

As described above, when the frame member 26 is bonded to and held in the container 200, the adhesion area can be increased. Thus, the bond strength can be raised, and the impact resistance can be increased. Moreover, if the vibrator 50 is put in the container 200 using the periphery of the frame member 26 as a guide, it is not necessary to position the vibrator 50, and it is possible to enhance the assembling property.

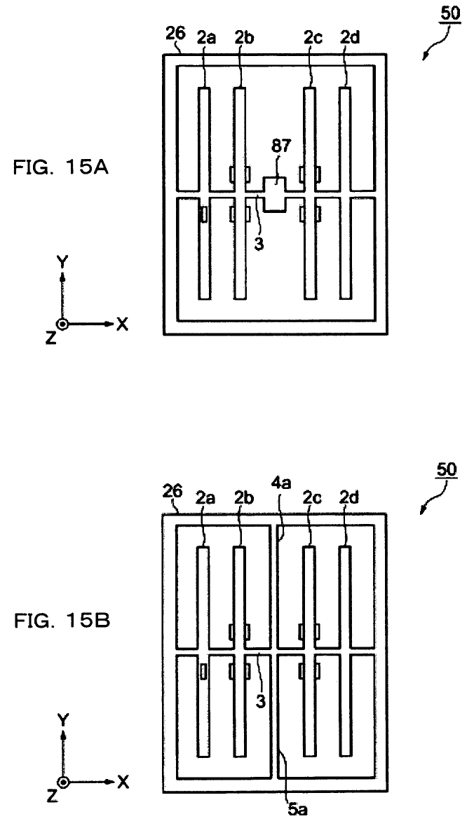

Modifications in Arrangement of Supporting Units 101751 FIG. 15A and FIG. 15B are schematics illustrating a modification in the arrangement of the supporting units of exemplary Embodiment 3.

In this modification, as shown in FIG. 15A, a supporting unit 87 may be provided in substantially the center of the length of the beam 3 connected to the vibrating bars 2a, 2b, 2c and 2d.

Since this enables the supporting unit 87 to be adhesively bonded to the frame member 26, it is possible to provide a vibrator having an increased adhesion area and an enhanced impact resistance.

As shown in FIG. 15B, the bar-shaped parts 4a and 5a may be caused to extend in the Y-direction to connect them to the frame member 26.

This enables the frame member 26 to be reinforced and prevents a vibrator from being damaged in assembling of the vibrator.

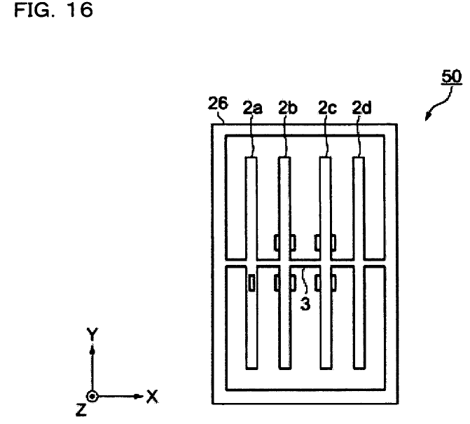

Further, another modification shown in FIG. 16 may be made.

FIG. 16 illustrates a construction in which the supporting units 4 and 5 between the vibrating bars 2b and 2c in exemplary Embodiment 3 are omitted and the frame member 26 is allowed to function as the supporting units, instead.

Since the supporting units 4 and 5 are not provided between the vibrating bar 2b and 2c, thus, the vibrator 50 can be made small.

Modification Having a Plurality of Detecting Units Arranged Therein

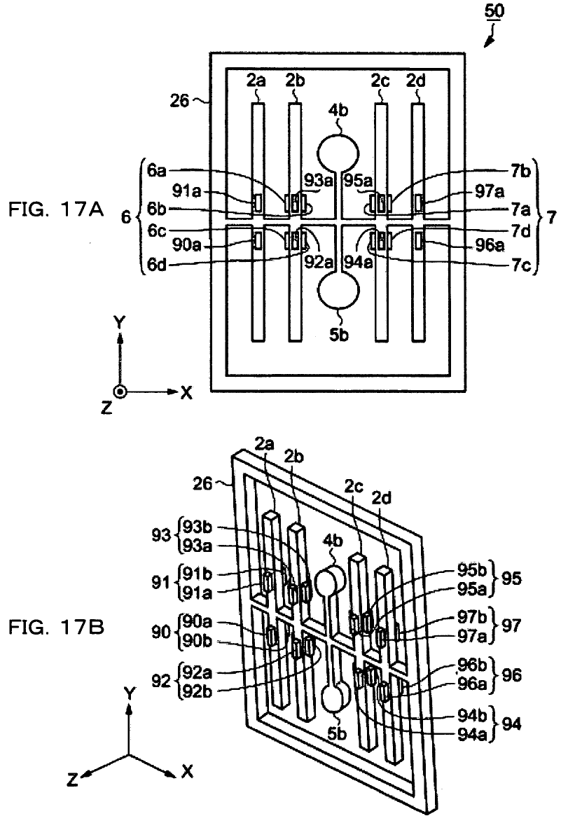

FIG. 17A is a schematic illustrating a modification when a plurality of detecting units is provided, and FIG. 17B is a schematic of FIG. 17A.

Detecting units 92 and 93 are provided in a vibrating bar 2b having a driving unit 6 including driving elements 6a, 6b, 6c and 6d. The detecting unit 92 includes detecting elements 92a and 92b provided on the X-Y plane with a mutual relation of the outside and inside in the vibrating bar 2b. Moreover, the detecting unit 93 includes detecting elements 93a and 93b provided on the X-Y plane with a mutual relation of the outside and inside in the vibrating bar 2b.

Similarly, detecting units 94 and 95 are provided in a vibrating bar 2c having a driving unit 7 including driving elements 7a, 7b, 7c and 7d. The detecting unit 94 includes detecting elements 94a and 94b, and the detecting unit 95 includes detecting elements 95a and 95b. In addition, the detecting units 92, 93, 94 and 95 are attached to positions slightly deviated from substantially the centers of the respective vibrating bars 2b and 2c on the X-Y plane.

The vibrating bar 2a is provided with detecting units 90 and 91. The detecting unit 90 includes detecting element 90a and 90b provided on the X-Y plane with a mutual relation of the outside and inside in the vibrating bar 2a. Moreover, the detecting unit 91 includes detecting element 91a and 91b provided on the X-Y plane with a mutual relation of the outside and inside in the vibrating bar 2a.

Similarly, the vibrating bar 2d is provided with the detecting units 96 and 97. The detecting unit 96 includes detecting element 96a and 96b. The detecting unit 97 includes detecting element 97a and 97b. In addition, the detecting units 90, 91, 96 and 97 are attached to positions on the X-Y plane slightly deviated from the center of the respective vibrating bars 2a and 2d.

The vibration of the respective vibrating bars 2a, 2b, 2c and 2d, which constitute the vibrator 50, in the drive mode and the detecting mode, is just the same as that described in exemplary Embodiment 3, so the description thereof will be omitted.

An effect obtained by providing a plurality of detecting units is that acceleration of the Z-direction, which is disturbance for the Y-axis rotation, can be detected, and an influence by the acceleration can be removed. When acceleration is applied in the Z-axis direction, four vibrating bars 2a, 2b, 2c and 2d are deformed in the same direction along the Z-axis. From the foregoing, detecting units are provided in at least two vibrating bars that vibrate in anti-phase to each other along the Z-axis during the Y-axis rotation, such that the acceleration can be distinguished from the Y-axis rotation. As an example, the detecting units 91 and 97 of the vibrating bars 2a and 2d are arranged in the vibrator 50 of FIG. 17, such that acceleration can be distinguished from the Y-axis rotation.

Further, detecting units can be arranged in the portions of the vibrating bars where a Coriolis force causes any deformation. As shown in FIG. 17, a plurality of detecting units may be provided in one vibrating bar. Further, an effect obtained by further providing a plurality of detecting units is that the deformation of many vibrating bars is detected, such that noises and errors in detection can be averaged in a calculating unit to detect the Y-axis rotation with high accuracy.

Applied Apparatus

Applied apparatus using the vibrators 1, 30, 40 and 50 of the above-described exemplary Embodiments 1, 2 and 3 may include an electronic apparatus, such as a mobile telephone, a digital camera, a video camera and a navigation system, which require a change in the posture thereof to be detected.

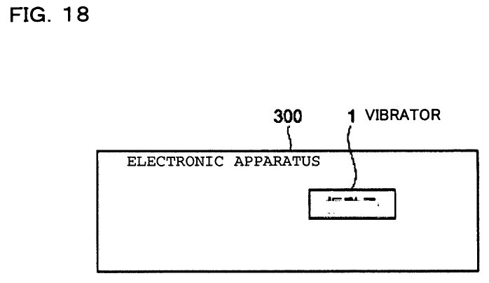

FIG. 18 is a schematic of an electronic apparatus. For example, the vibrator 1 in exemplary Embodiment 1 is built in an electronic apparatus 300, such as a digital camera, such that the posture of a digital camera can be detected and the shake of the camera can be corrected when a shutter is pushed. In addition, the vibrators 30, 40 and 50 described in the present exemplary embodiments may be used as a vibrator.

As described above, in the electronic apparatus, the vibrators 1, 30, 40 and 50 of the exemplary embodiments provided in the electronic apparatus detect a change in the posture of the electronic apparatus as a change in the posture of the vibrators 1, 30, 40 and 50, such that the aforementioned effect can be obtained.

1. A vibratory gyroscope, comprising:
first, second, third and fourth vibrating bars extending parallel to each other substantially in the same plane, the first vibrating bar and the second vibrating bar being arranged at an outermost side, the third vibrating bar and the fourth vibrating bar being arranged between the first vibrating bar and the second vibrating bar, the third vibrating bar being arranged at a position near the first vibrating bar, and the fourth vibrating bar being arranged at a position near the second vibrating bar;
a bar-shaped beam extending substantially perpendicular to the four vibrating bars in the same plane and connected to the four vibrating bars;
bar-shaped supporting units to support the beam;
driving units arranged at at least two of the four vibrating bars; and
a detecting unit arranged at at least one of the four vibrating bars;
the vibrating bars being driven and vibrated by the driving units, and the rotation around a direction in which the vibrating bars extend, as the rotational axis, is detected by deformation of the at least one vibrating bar on which the detecting unit is arranged.

2. The vibratory gyroscope according to claim 1,
the supporting units being formed to extend in the direction in which the vibrating bars extend, and to intersect the beam.

3. The vibratory gyroscope according to claim 2,
the supporting units being formed to intersect at substantially a center of a length of the beam.

4. The vibratory gyroscope according to claim 1,
the supporting units being formed at ends of the beam which extend outward from the first vibrating bar and the second vibrating bar.

5. The vibratory gyroscope according to claim 1,
the supporting units include a frame member surrounding the first to fourth vibrating bars from an outside.

6. The vibratory gyroscope according to claim 1,
the beam being connected to the vibrating bars at substantially a center of lengths of the first to fourth vibrating bars.

7. The vibratory gyroscope according to claim 6,
the first and third vibrating bars and the second and fourth vibrating bars being provided at positions which are symmetrical with respect to a straight line passing through a center of the beam and parallel to the vibrating bars.

8. The vibratory gyroscope according to claim 1,
the driving units being included in the first vibrating bar and the second vibrating bar, or the driving units being included in the third vibrating bar and the fourth vibrating bar.

9. The vibratory gyroscope according to claim 8,
when the driving units are provided in the first vibrating bar and the second vibrating bar, the driving units drive the first vibrating bar and the second vibrating bar so that the vibrations of the first and second vibrating bars are in anti-phase to each other, and
when the driving units are provided in the third vibrating bar and the fourth vibrating bar, the driving units drive the third vibrating bar and the fourth vibrating bar so that the vibrations of the third and fourth vibrating bars are in anti-phase to each other.

10. The vibratory gyroscope according to claim 9,
the detecting unit being included in at least the first vibrating bar and the second vibrating bar or at least the third vibrating bar and the fourth vibrating bar or at least the first vibrating bar and the third vibrating bar, or at least the second vibrating bar and the fourth vibrating bar.

11. The vibratory gyroscope according to claim 1,
the driving units being included in the first, second, third and fourth vibrating bars.

12. The vibratory gyroscope according to claim 11,
the driving units drive the vibration of the first, second, third and fourth vibrating bars such that the vibration of the first vibrating bar and the vibration of the second vibrating bar are in phase to each other, the vibration of the third vibrating bar and the vibration of the fourth vibrating bar are in phase to each other, and the vibration of the first vibrating bar and the vibration of the third vibrating bar are in anti-phase to each other.

13. The vibratory gyroscope according to claim 12,
the detecting unit being included in at least the first vibrating bar and the fourth vibrating bar, or at least the second vibrating bar and the third vibrating bar, or at least the first vibrating bar and the third vibrating bar, or at least the second vibrating bar and the fourth vibrating bar.

14. The vibratory gyroscope according to claim 11,
the driving units driving the vibration of the first, second, third and fourth vibrating bars such that the vibration of the first vibrating bar and the vibration of second vibrating bar are in anti-phase to each other, the vibration of the third vibrating bar and the vibration of the fourth vibrating bar are in anti-phase to each other, and the vibration of the first vibrating bar and the vibration of the third vibrating bar are in anti-phase to each other.

15. The vibratory gyroscope according to claim 14,
the detecting unit being included in at least the first vibrating bar and second vibrating bar, or at least the first vibrating bar and the third vibrating bar, or at least the second vibrating bar and the fourth vibrating bar, or at least the third vibrating bar and the fourth vibrating bar.

16. An electronic apparatus, comprising:
the vibratory gyroscope according to claim 1.
